(19) United States
(12) Patent Application Publication
(10) Pub. No.: US 2015/0147551 A1
(43) Pub. Date: May 28, 2015

(54) USE OF AN ALLOY OF THERMOPLASTIC STARCH AND FPO IN THE MANUFACTURE OF AN ADHESIVE ULTRATHIN WATERPROOF-BREATHABLE FILM

(71) Applicant: ARKEMA FRANCE, Colombes (FR)

(72) Inventors: Benoît Brule, Beaumont-le-roger (FR); Guillaume Le, Colombelles (FR); Perrine Babin, Rouen (FR); Laurent B. Cartier, Wayne, PA (US); Frédéric Malet, Rouen (FR)

(21) Appl. No.: 14/411,762

(22) PCT Filed: Jun. 7, 2013
(86) PCT No.: PCT/FR2013/051326

§ 371 Date: Dec. 29, 2014

(30) Foreign Application Priority Data
Jun. 27, 2012 (FR) 1256142

(51) Int. Cl. B32B 27/12; B32B 27/32; C09J 133/14; C09J 133/08; C09J 135/02

(52) U.S. Cl. CPC B32B 27/12; C09J 133/08; C09J 135/02; C09J 133/14; B32B 27/32; B32B 2307/73; B32B 2307/724
USPC 428/220; 524/53; 523/447; 442/290; 442/398; 428/317.7; 442/304; 442/320

(57) ABSTRACT

The present invention relates to the use of thermoplastic starch in the manufacture of an adhesive and ultrathin waterproof-breathable film, said thermoplastic starch being provided in the form of an alloy with at least one hydrophilic functionalized polyolefin obtained either by copolymerization or by grafting of a polyolefin backbone with an unsaturated monomer, said unsaturated monomer being grafted by PEGs and/or forming a metal salt. This film can be used in a textile product in the medical field, hygiene, luggage, the clothing industry, the garment industry, domestic or household equipment, furniture, fitted carpets, the automobile industry, industry, in particular industrial filtration, agriculture and/or the construction industry.

### TECHNICAL FIELD

The technical field to which the invention relates is that of waterproof-breathable films used in the textile field.

Such a waterproof-breathable film is simultaneously permeable to water vapor and impermeable to water.

### STATE OF THE ART

Many technical fields require textiles having improved and prolonged waterproof-breathable properties. Mention may in particular be made of the medical field, medical equipment, surgical gowns, carpets, mattresses, dressings, protective clothing; agriculture, agricultural films; wrapping, packaging; military equipment, maritime equipment, in particular marine coverings; transportation, aeronautics, the automobile industry; sport; leisure activities; computing, electronics, furniture; decoration; equipment for babies or for children; exterior equipment; the insulation of the walls of a building, roof-decking films.

A waterproof-breathable film is a flexible film, the role of which, on the one hand, is to prevent external elements, such as dust, pollen, sand, rain and snow, from infiltrating through the textile and, on the other hand, to prevent the moisture produced, for example by human activity, from accumulating in the textile. This film makes possible the discharge of the water vapor from the textile. The use of a waterproof-breathable film makes it possible to have a textile which breathes and which is thus healthy for those who use it.

The permeability to water vapor is evaluated using the parameter MVTR (Moisture Vapor Transmission Rate). In particular, it is desirable for a waterproof-breathable film to exhibit an MVTR value, measured by the standard ASTM E96, of at least 70 g/m² for 24 hours at 23° C. for a relative humidity of 50% and a film thickness of 25 μm. For the abovementioned applications, it is desirable in particular for the minimum permeability to be at least 350 g/m² under the same measurement conditions, when the film used adheres to the surface of a textile. It is also desirable for the adhesion of the film to the textile not to detrimentally change as the textile is used, in particular when the amount of water vapor to be discharged is greater in the case of a significant increase in the temperature. In other words, a search is under way for a waterproof-breathable textile product which is not easily decomposed by prolonged exposure to moisture. Furthermore, the enhancement in the waterproof-breathable properties and the adhesion of the film to the textile must not take place to the detriment of the flexibility or of the fineness (thickness) of the textile. The search is thus under way for a waterproof-breathable textile product (hereinafter treated textile or laminated product) which exhibits a high permeability to water vapor and a good lifetime, in order to guarantee the continuity thereof, while having the appearance of a “bare” textile without specific treatment.

The known films are manufactured from synthetic polymers. In point of fact, synthetic polymers are manufactured from non-renewable starting materials. Attempts are being made to limit their amount in the manufacture of a waterproof-breathable film. The aim is thus to find a film which is obtained at least partially from natural (or bioresourced) starting materials and which exhibits a permeability at least as good as that of a film obtained from synthetic polymers. In particular, the aim is to find a film which is obtained at least partially from natural starting materials and which satisfies the permeability requirements indicated above.

Finally, the films of the prior art are obtained by shaping a blend comprising different polymers known for their waterproof-breathable properties. The shaping can be carried out according to any known extrusion process, such as flat die extrusion calendering, extrusion-acrylic resin coating or extrusion/blow molding. Generally, despite a high heating power, it is not possible to obtain films with a thickness of less than 25 μm. The aim is thus to find a waterproof-breathable film which can be easily manufactured with conventional devices for the manufacture of thermoplastic films and at a heating or extrusion temperature within the range from 100° C. to 300° C., preferably within the range from 150° C. to 250° C.

### SUMMARY OF THE INVENTION

To this end, the invention provides for the use of thermoplastic starch in the manufacture of an adhesive and ultrathin waterproof-breathable film, adhesive in particular on the surface of at least one textile material, said thermoplastic starch being provided in the form of an alloy with at least one hydrophilic functionalized polyolefin obtained either by copolymerization or by grafting of a polyolefin backbone with an unsaturated monomer, said unsaturated monomer being grafted by PEGs and/or forming a metal salt.

Preferably, the percentage of thermoplastic starch represents from 10% to 90% of the weight of the alloy, preferably from 30% to 80%, more preferably from 40% to 70%, more preferably from 50% to 70%, of the weight of the alloy.

Preferably, the hydrophilic polyolefin comprises at least 10% by weight, preferably at least 20% by weight, preferably at least 30% by weight, of polyethylene glycol (PEG) and/or of metal salt, with regard to the weight of polyolefin.

According to a specific embodiment of the invention, the alloy additionally comprises at least one hydrophilic TPE chosen from copolymers comprising polyamide blocks and PEG blocks (PEBAs), copolymers comprising polyester blocks and PEG blocks (COPEs), copolymers comprising polyurethane blocks and PEG blocks (TPUs) and their blends, said hydrophilic TPE preferably representing a content of 1% to 99%, preferably of 20% to 80%, of the weight of the alloy.

Another subject matter of the present invention is an adhesive and ultrathin waterproof-breathable film, characterized in that it comprises an alloy of thermoplastic starch and of hydrophilic polyolefin, said polyolefin comprising at least one polyethylene unit and at least one unsaturated monomer to which is grafted a content of at least 10% by weight, preferably at least 20% by weight, preferably at least 30% by weight, preferably at least 40% by weight, of polyethylene glycol (PEG) and/or of metal salt, with regard to the weight of the polyolefin.

Preferably, the percentage of the thermoplastic starch represents from 10% to 90% and the percentage of hydrophilic polyolefin represents from 90% to 10% of the weight of the alloy.

According to one embodiment, said functionalized polyolefin comprises a grafting by a monomer chosen from the group consisting of unsaturated carboxylic acids, unsaturated carboxylic anhydrides, vinyl monomers, acrylic monomers and a mixture of these.

According to a specific embodiment, the functionalized polyolefin is chosen from the group consisting of ethylene/acrylic ester copolymers, ethylene/acrylic ester/maleic anhydride copolymers and ethylene/acrylic ester/glycidyl methacrylate copolymers.

Advantageously, the film according to the invention has a thickness of less than or equal to 25 μm, preferably within the range from 5 to 25 μm.

Another subject matter of the present invention is a process for the manufacture of the film according to the invention, comprising the stages of:

a) making available a blend of starch, of plasticizer and of water;

b) making available the hydrophilic polyolefin as defined by either one of claims 1 and 3;

c) extruding the blend of stage a) and then adding the polyolefin of stage b) to the blend at the end of extrusion, in particular at a temperature greater than the melting point of the polymer(s) of stage a) and than the melting point of the starch;

d) drawing the blend in order to form a film.

According to one embodiment of the process of the invention, the stage of drawing the blend is carried out by extrusion/blow molding.

According to another embodiment of the process of the invention, the stage of drawing the blend is carried out by cast film extrusion.

Preferably, stage c) is carried out at a temperature within the range from 100° C. to 300° C., preferably from 150° C. to 250° C.

Another subject matter of the present invention is a laminated product comprising at least one textile material and at least one waterproof-breathable film according to the invention, said film adhering to at least one surface of the textile material with a peel strength within the range from 0.5 to 50 N, preferably from 0.5 to 10 N.

Preferably, said at least one textile material is provided in the form of a porous membrane, of a woven textile or of a nonwoven textile.

Preferably, said at least one textile material comprises synthetic fibers, in particular synthetic fibers obtained from bioresourced starting materials, natural fibers, artificial fibers manufactured from natural starting materials, mineral fibers and/or metal fibers.

Said at least one textile material constitutes, for example, a felt, a filter, a film, a gauze, a cloth, a dressing, a layer, a fabric, an item of knitwear, an item of clothing, a garment, an item of bedding, an item of furniture, a curtain, a compartment covering, a functional technical textile, a geotextile and/or an agrotextile.

Another subject matter of the present invention is the use of a film according to the invention in the medical field, hygiene, luggage, the clothing industry, the garment industry, domestic or household equipment, furniture, fitted carpets, the automobile industry, industry, in particular industrial filtration, agriculture and/or the construction industry.

The film according to the invention can be used in particular in the medical field, hygiene, luggage, the clothing industry, the garment industry, domestic or household equipment, furniture, fitted carpets, the automobile industry, industry, in particular industrial filtration, agriculture and/or the construction industry. Such a film exhibits both good durability and improved permeability to water vapor. The film retains over time its property of barrier to the external elements which might infiltrate into the textile. The improvement in the permeability of the film to water vapor promotes ventilation through the textile.

### DETAILED ACCOUNT OF THE EMBODIMENTS OF THE INVENTION

The invention is now described in more detail and without implied limitation in the description which follows.

The hydrophilic functionalized polyolefin used in the alloy according to the invention is obtained either by copolymerization or by grafting of a polyolefin backbone with an unsaturated monomer comprising an anhydride, acid or epoxide functional group, this hydrophilic functionalized polyolefin being grafted with polyether units, generally comprising an amine end, in particular polyoxyethylene glycol (PEG) units, and/or said unsaturated monomer forming a metal salt, so that the polyolefin is an ionomer.

Polyolefin backbone is understood to mean, within the meaning of the invention, a polyolefin which is a homopolymer or copolymer of α-olefins or of diolefins, such as, for example, ethylene, propylene, 1-butene, 1-octene or butadiene. Examples of α-olefins having from 3 to 30 carbon atoms as optional comonomers comprise propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicosene, 1-docosene, 1-tetracosene, 1-hexacosene, 1-octacosene and 1-triacontene. These α-olefins can be used alone or as a mixture of two or more than two.

Mention may be made, as examples of polyolefin, of:

homopolymers and copolymers of ethylene; mention may in particular be made, as example of polyethylenes, of: low density polyethylene (LDPE), high density polyethylene (HDPE), linear low density polyethylene (LLDPE), very low density polyethylene (VLDPE), the polyethylene obtained by metallocene catalysis, that is to say the polymers obtained by copolymerization of ethylene and α-olefin, such as propylene, butene, hexene or octene, in the presence of a single-site catalyst generally comprising a zirconium or titanium atom and two cyclic alkyl molecules bonded to the metal. More specifically, the metallocene catalysts are usually composed of two cyclopentadiene rings bonded to the metal. These catalysts are frequently used with aluminoxanes as cocatalysts or activators, preferably methylaluminoxane (MAO). Hafnium can also be used as metal to which the cyclopentadiene is attached. Other metallocenes can include transition metals from Groups IVa, Va and VIa. Metals of the lanthanide series can also be used.

propylene homopolymers or copolymers.

ethylene/α-olefin copolymers, such as ethylene/propylene, EPRs (abbreviation of ethylene/propylene rubber) and ethylene/propylene/diene (EPDM).

styrene/ethylene-butene/styrene (SEBS), styrene/butadiene/styrene (SBS), styrene/isoprene/styrene (SIS) or styrene/ethylene-propylene/styrene (SEPS) block copolymers.

copolymers of ethylene with at least one product chosen from salts or esters of unsaturated carboxylic acids, such as, for example, alkyl (meth)acrylates, it being possible for the alkyls to have up to 24 carbon atoms.

Examples of alkyl acrylate or methacrylate are in particular methyl methacrylate, ethyl acrylate, n-butyl acrylate, isobutyl acrylate or 2-ethylhexyl acrylate.

vinyl esters of saturated carboxylic acids, such as, for example, vinyl acetate or propionate.

unsaturated epoxides.

Examples of unsaturated epoxides are in particular:

aliphatic glycidyl esters and ethers, such as allyl glycidyl ether, vinyl glycidyl ether, glycidyl maleate, glycidyl itaconate, glycidyl acrylate and glycidyl methacrylate, and

alicyclic glycidyl esters and ethers, such as 2-cyclohexen-1-yl glycidyl ether, diglycidyl cyclohexene-4,5-dicarboxylate, glycidyl cyclohexene-4-carboxylate, glycidyl 5-norbornene-2-methyl-2-carboxylate and diglycidyl endo-cis-bicyclo[2.2.1]hept-5-ene-2,3-dicarboxylate.

unsaturated carboxylic acids, their salts or their anhydrides.

Examples of unsaturated dicarboxylic acid anhydrides are in particular maleic anhydride, itaconic anhydride, citraconic anhydride or tetrahydrophthalic anhydride.

dienes, such as, for example, 1,4-hexadiene.

or vinyl esters of saturated carboxylic acids, such as vinyl acetate, it being possible for the proportion of comonomer to reach 40% by weight.

EPR (ethylene/propylene rubber) elastomers

EPDM (ethylene/propylene/diene) elastomers

blends of polyethylene with an EPR or an EPDM

it being possible for the ethylene/alkyl (meth)acrylate copolymers to comprise up to 60% by weight of (meth)acrylate and preferably from 2 to 40%

ethylene/alkyl (meth)acrylate/maleic anhydride copolymers obtained by copolymerization of the three monomers, the proportions of (meth)acrylate being as the above copolymers, the amount of maleic anhydride being up to 10% by weight and preferably from 0.2% to 6% by weight.

ethylene/vinyl acetate/maleic anhydride copolymers obtained by copolymerization of the three monomers, the proportions being the same as in the preceding copolymer.

Mention may be made, as an example, of ethylene copolymers, such as the copolymers, obtained by the radical route under high pressure, of ethylene with vinyl acetate, (meth)acrylic esters of (meth)acrylic acid and of an alcohol having from 1 to 24 carbon atoms and advantageously from 1 to 9, or radical terpolymers additionally using a third monomer chosen from unsaturated monomers which can copolymerize with ethylene, such as acrylic acid, maleic anhydride or glycidyl methacrylate. These flexible copolymers can also be copolymers of ethylene with α-olefins of 3 to 8 carbon atoms, such as EPRs, or very low density copolymers of ethylene with butene, hexene or octene with a density of between 0.860 and 0.910 g/cm³ obtained by metallocene or Ziegler—Natta catalysis. Flexible polyolefins is also understood to mean the blends of two or more flexible polyolefins.

The invention is of particular use for copolymers of ethylene and alkyl (meth)acrylates. The alkyl can have up to 24 carbon atoms. Preferably, the (meth)acrylates are chosen from those cited above. These copolymers advantageously comprise up to 40% by weight of (meth)acrylate and preferably from 3% to 35%. Their MFI is advantageously between 0.1 and 50 (at 190° C., 2.16 kg).

As regards unsaturated monomer X, it can, for example, be an unsaturated carboxylic acid anhydride. The unsaturated carboxylic acid anhydride can be chosen, for example, from maleic anhydride, itaconic anhydride, citraconic anhydride, allylsuccinic anhydride, cyclohex-4-ene-1,2-dicarboxylic anhydride, 4-methylenecyclohex-4-ene-1,2-dicarboxylic anhydride, bicyclo[2.2.1]hept-5-ene-2,3-dicarboxylic anhydride and x-methylbicyclo[2.2.1]hept-5-ene-2,2-dicarboxylic anhydride. Use is advantageously made of maleic anhydride. It would not be departing from the scope of the invention to replace all or part of the anhydride with an unsaturated carboxylic acid, such as, for example, (meth)acrylic acid.

The monomer can also be an unsaturated epoxide of the aliphatic glycidyl ester or ether type, such as allyl glycidyl ether, vinyl glycidyl ether, glycidyl maleate, glycidyl itaconate, glycidyl acrylate and glycidyl methacrylate.

Advantageously, the polyolefin backbones to which the X residues are attached are polyethylenes grafted with X or copolymers of ethylene and X which are obtained, for example, by radical polymerization.

Use is advantageously made of ethylene/maleic anhydride and ethylene/alkyl (meth)acrylate/maleic anhydride copolymers. These copolymers comprise from 0.2% to 10% by weight of maleic anhydride and from 0% to 40% by weight and preferably from 5% to 40% by weight of alkyl (meth)acrylate. Their MFI is between 5 and 100 (190° C., 2.16 kg). The alkyl (meth)acrylates have already been described above. The melting point is between 60° C. and 100° C.

As regards the polyether units having an amine end, or polyetheramines, they are preferably monoamines, but also polyamines, having a molecular weight of between approximately 100 and 12 000 g/mol; the polyether blocks of these polyetheramines are addition products of cyclic ethers, such as ethylene oxide (EO), propylene oxide (PO) or their blends comprising glycols chosen in particular from the group consisting of ethylene glycol, glycerol, 1,2-propanediol and pentaerythritol. Use is made of polyether blocks of polyethylene glycol (PEG) type according to the invention, optionally in combination with polypropylene glycol (PPG), copolymers of polyethylene glycol and of polypropylene glycol, poly(1,2-butylene glycol) and poly(tetramethylene glycol) (PTMG). The polyetheramines used according to the invention can be obtained according to well known amination processes, such as described in particular in the U.S. Pat. No. 3,654,370, U.S. Pat. No. 4,152,353, U.S. Pat. No. 4,618,717 and U.S. Pat. No. 5,457,147.

Use is preferably made of polyether units or blocks of the polyethylene glycol monoamine copolymers type, in the form of short segments (Mn between 100 and 10 000 g/mol and preferably between 250 and 5000 g/mol); such polyether monoamine compounds are described in particular in the patents WO 98/51742 and U.S. Pat. No. 6,465,606.

However, other polyethers, such as the polypropylene glycol (PPG) or polytetramethylene glycol (PTMG) or their copolymers or their blends, can also be used. The addition of the polyether monoamine units to the polyolefin backbone comprising X is carried out by reaction of an amine functional group of the polyether with X. Advantageously, when X carries an acid or anhydride functional group, imide or amide junctions are thus created.

Advantageously, there is on average between 0.1% and 25% by weight of X per chain attached to the polyolefin backbone. A person skilled in the art can easily determine these amounts by FTIR analysis.

The addition of the polyether having an amine end to the polyolefin backbone comprising X is preferably carried out in the molten state. It is thus possible, in an extruder, to knead the polyether and the backbone at a temperature generally between 150° C. and 300° C.

The ratios by weight of the amount of polyether having an amine end introduced to the amount of functionalized polyolefin introduced as a blend are between 1/99 and 80/20 and preferably between 20/80 and 50/50.

The polyolefin can be blended with the functionalized polyolefin grafted with polyether units of the invention; use may be made of any type of polyolefin as described below for the polyolefin backbone; in particular, copolymers of ethylene and of alkyl (meth)acrylate are particularly appropriate.

The compositions of the invention can be prepared by melt blending in extruders (mono- or twin-screw extruders), Buss co-kneaders, internal mixers and generally the normal devices for blending thermoplastics and preferably corotating twin-screw extruders.

The compositions of the invention can be prepared in one stage in an extruder. The functionalized polyolefin (for example, an ethylene/alkyl (meth)acrylate/maleic anhydride copolymer) and then the polymer having an amine end are introduced in the first zones.

The mean residence time of the molten material in the extruder can be between 5 seconds and 10 minutes and preferably between 10 and 60 seconds. The yield of this addition is evaluated by selective extraction of the free polyethers, that is to say those which have not reacted to form the final grafted copolymer comprising polyether blocks.

Advantageously, the proportion of grafted polyether blocks is approximately 50% of the amount introduced.

The compositions of the invention can also comprise various additives, in particular slip agents, such as silica, N,N′-ethylenebisamide, calcium stearate or magnesium stearate. They can also comprise antioxidants, UV stabilizers, inorganic fillers or coloring pigments.

According to another embodiment, the hydrophilic functionalized polyolefin used in the alloy according to the invention is chosen from ionomeric hydrophilic polyolefins (hereinafter “ionomers”). Ionomers is understood to mean, within the meaning of the invention, ionic copolymers of an olefin, such as ethylene, with a metal salt of an unsaturated carboxylic acid, such as acrylic acid, methacrylic acid or maleic acid, and optionally other comonomers. At least one cation of an alkali metal, transition metal or alkaline earth metal, such as lithium, sodium, potassium, magnesium, calcium or zinc, or a combination of these cations, is used to neutralize a portion of the acid groups in the copolymer, resulting in a thermoplastic resin exhibiting improved properties.

For example, “ethylene/(meth)acrylic acid (abbreviated to E/(M)AA)” denotes a copolymer of ethylene (abbreviated to E) and of acrylic acid (AA) and/or of ethylene and of methacrylic acid (MAA), which can subsequently be at least partially neutralized by one or more alkali metals, transition metals or cations of alkaline earth metals to form an ionomer. Mention may in particular be made of the ionomers at least partially neutralized by potassium cations.

Terpolymers can also be manufactured from an olefin, such as ethylene, an unsaturated carboxylic acid and other comonomers, such as alkyl (meth)acrylates (providing more flexible resins) which can be neutralized to form (flexible) ionomers.

According to an advantageous embodiment, the ionomeric polyolefin used in the alloy according to the invention comprises:

(i) at least one E/X/Y, where E is an ethylene copolymer, X is an α,β-unsaturated C₃ to C₈ carboxylic acid and Y is a comonomer chosen from an alkyl acrylate and alkyl methacrylate in which the alkyl groups have from one to eight carbon atoms, in which X represents approximately 2-30% by weight of the E/X/Y copolymer and Y represents approximately from 0 to 40% by weight of the E/X/Y copolymer, and

(ii) one or more organic acids or their salts, where the carboxylic acid functionalities are at least partially neutralized by potassium.

Ionomers which are particularly preferred in the present invention comprise E/(M)AA dipolymers having from 2% to 30% by weight of (M)AA with an average molecular weight within the range from 80 000 to 500 000, at least partially neutralized by potassium.

The neutralization can be carried out by manufacturing first the E/(M)AA copolymer and by then treating the copolymer with (an) inorganic base(s) of an alkali metal or alkaline earth metal or (a) transition metal cation(s).

The ionomeric polyolefins according to the invention are at least partially neutralized by potassium but other cations (for example of sodium, of magnesium or of zinc) can also be present in the ionomeric polyolefin compositions of the invention.

The methods for preparation of the ionomers of copolymers are well known to a person skilled in the art. For example, the copolymers of ethylene and of α,β-unsaturated C₃ to C₈ carboxylic acid are placed in the molten state and then at least partially neutralized.

As indicated above, the acid/ethylene ionomers can be bulk blended in the molten state with other ionomers or polymers and/or modified by the incorporation of organic acids or their salts. The above copolymers are melt blended with organic acids or their salts, in particular aliphatic organic acids or their salts, monofunctional organic acid(s) having from 6 to 36 carbon atoms or their salts. Preferably, the at least partially neutralized organic acids are monofunctional aliphatic acids having less than 36 carbon atoms or salts of these. Preferably, more than 80% of all the acid components in the blend are neutralized; preferably, more than 90% are neutralized. More preferably, 100% of the acid components in the ionomeric polyolefin are neutralized by potassium.

According to this specific embodiment of the invention, the acidic components in the composition of the invention are at least partially neutralized by potassium. The organic acids or the salts of these acids used in the present invention are preferably chosen from stearic fatty acid, oleic fatty acid, erucic acid and behenic acid. Stearic acid and oleic acid are preferred.

Preferably, the organic acids or their salts are added in an amount of at least 5% (by weight) of the total amount of copolymer and organic acid. More preferably, the organic acids or their salts are added in an amount of at least 15%, more preferably still at least 30%. Preferably, the organic acid(s) are added in an amount ranging up to 50% (by weight), with regard to the total amount of copolymer and organic acid. Preference is given to polyolefin compositions in which the organic acids or their salts are added in an amount ranging up to 45%.

The ionomers can optionally comprise a third monomer which disrupts the crystallinity of the polymer. These acid copolymers, where the α-olefin is ethylene, are denoted E/X/Y, in which E is ethylene, X is the α,β-unsaturated carboxylic acid, in particular acrylic acid or methacrylic acid, and Y is the comonomer. The preferred comonomers in this case are C₁ to C₈ comonomers, such as an alkyl acrylate or methacrylate esters. X typically represents up to 35% by weight of the copolymer and Y typically up to 50% by weight of the copolymer.

The copolymers based on ethylene and on acid are in particular terpolymers: ethylene/(meth)acrylic acid/n-butyl (meth)acrylate, ethylene/(meth)acrylic acid/isobutyl (meth)acrylate, ethylene/(meth)acrylic acid/methyl (meth)acrylate or ethylene/(meth)acrylic acid/ethyl (meth)acrylate and in particular ethylene/(meth)acrylic acid/butyl (meth)acrylate copolymers.

The ionomers of the invention this invention can be produced by: (a) melt blending (1) ethylene and α,β-unsaturated C₃ to C₈ acid and (b) adding a sufficient amount of source of cations (preferably at least partially comprising potassium cations) in the presence of water, in order to obtain the desired level of neutralization of all the acid groups.

The blend of ionomer(s) and of organic acid(s) of the specific embodiment of the invention can be produced by melt blending the organic acid (or salt of the latter) with an ionomer in the molten state manufactured separately, followed optionally by neutralizing the blend with identical or different cations in order to achieve the desired levels of neutralization of the blend of ionomer and organic acid obtained. Preferably, the non-neutralized terpolymers and the organic acids are bulk melt blended and then neutralized in situ. In this case, the desired level of neutralization can be achieved in a single stage.

For example, ethylene copolymers comprising (meth)acrylic acid can be melt blended with either potassium stearate (or potassium salts of other organic acids); or, in an alternative form, with stearic acid (or other organic acids), then neutralized in situ with a source of potassium cations in order to convert the copolymers modified in the organic acid to acid ionomers modified with potassium according to different degrees of neutralization, including 100%.

The organic acids used in the present invention include (saturated, unsaturated or polyunsaturated) monofunctional aliphatic acids, in particular those having from 6 to 36 carbon atoms. Organic acids which are preferred in the present invention comprise caproic acid, caprylic acid, capric acid, lauric acid, stearic acid, behenic acid, erucic acid, oleic acid and linoleic acid. The use of branched isomers of stearic acid and/or oleic acid, such as 2-methylstearic acid and its salts and 2-methyloleic acid and the salts of the latter, in the present invention should also be noted. Hydroxylated acids, such as 12-hydroxystearic acid, are preferred. Preferably, the potassium salts of these acids are used.

Examples of unsaturated carboxylic acid which are preferred for the ionomeric hydrophilic polyolefins are in particular: acrylic acid, methacrylic acid, fumaric acid, maleic anhydride, monomethyl maleate, monoethyl maleate, and the like; acrylic acid and/or methacrylic acid are particularly preferred. Examples of polar monomers which can act as copolymerization components comprise vinyl esters, such as vinyl acetate and vinyl propionate; esters of unsaturated carboxylic acids, such as methyl acrylate, ethyl acrylate, isopropyl acrylate, n-butyl acrylate, isobutyl acrylate, n-hexyl acrylate, isooctyl acrylate acrylate, methyl methacrylate, dimethyl maleate and diethyl maleate, carbon monoxide; and the like; in particular, esters of unsaturated carboxylic acids are appropriate copolymerization components.

Mention may also be made of ethylene/unsaturated carboxylic acid copolymers which are zinc ionomers and in particular those having a content of unsaturated carboxylic acid of 1% to 25% by weight, in particular of 5% to 20% by weight. The content of the polar monomer which can be copolymerized is, for example, 40% by weight or less, preferably 30% or less. The zinc ionomer preferably has a degree of neutralization of approximately 10% to 90%, in particular of approximately 15% to 80%.

In addition, the copolymer can be blended with one or more conventional ionomeric copolymers (for example, dipolymers, terpolymers, and the like) and/or the copolymer can be blended with one or more conventional thermoplastic resins, preferably hydrophilic thermoplastic resins. Specifically, the ionomers of the present invention can be blended with nonionic thermoplastic resins in order to adjust the properties of the product. The nonionic thermoplastic resins include in particular thermoplastic elastomers, such as polyurethane, polyetherester, polyamideether, polyetherurea, PEBAX (a family of block copolymers based on polyether-block-amide, supplied commercially by Arkema); styrene/butadiene/styrene, block copolymers (SBSs); styrene/(ethylene-butylene block copolymers)/styrene, and the like, polyamides (oligomeric and polymeric), polyesters, polyvinyl alcohols; polyolefins comprising of PE, PP, E/P copolymers, and the like; copolymers of ethylene with different comonomers, such as vinyl acetate, (meth)acrylates, (meth)acrylic acid, epoxy-functionalized monomer, CO, vinyl alcohol, and the like, polymers functionalized with grafting of maleic anhydride, and the like, epoxidation, elastomers, such as EPDM, catalyzed by a metallocene and a PE copolymer, and the like.

Advantageously, the alloy used in the invention additionally comprises at least one hydrophilic TPE chosen from copolymers comprising polyamide blocks and PEG blocks (PEBAs), copolymers comprising polyester blocks and PEG blocks (COPEs), copolymers comprising polyurethane blocks and PEG blocks (TPUs) and their blends, said hydrophilic TPE preferably representing a content of from 1% to 99%, preferably from 20% to 80%, of the weight of the alloy.

Thermoplastic elastomer polymer (TPE) is understood to mean a block copolymer alternately comprising “hard” or “rigid” blocks or segments (with a rather thermoplastic behavior) and “soft” or “flexible” blocks or segments (with a rather elastomeric behavior). Mention may respectively be made, as an example of copolymer comprising hard blocks and comprising soft blocks, of (a) copolymers comprising polyester blocks and polyether blocks (hereinafter COPEs or copolyetheresters), (b) copolymers comprising polyurethane blocks and polyether or polyester blocks (also known as TPUs, abbreviation of thermoplastic polyurethanes) and (c) copolymers comprising polyamide blocks and polyether blocks (also known as PEBAs according to the IUPAC).

(a) Regarding the COPEs or copolyetheresters, these are copolymers comprising polyester blocks and polyether blocks. They are composed of soft polyether blocks resulting from polyetherdiols and of rigid polyester blocks which result from the reaction of at least one dicarboxylic acid with at least one chain-lengthening short diol unit. The polyester blocks and the polyether blocks are connected via ester bonds resulting from the reaction of the acid functional groups of the dicarboxylic acid with the OH functional groups of the polyetherdiol. The linking of the polyethers and diacids forms the soft blocks while the linking of the glycol or butanediol with the diacids forms the rigid blocks of the copolyetherester. The chain-lengthening short diol can be chosen from the group consisting of neopentyl glycol, cyclohexanedimethanol and aliphatic glycols of formula HO(CH₂)ₙOH in which n is an integer having a value from 2 to 10.

Advantageously, the diacids are aromatic dicarboxylic acids having from 8 to 14 carbon atoms. Up to 50 mol % of the aromatic dicarboxylic acid can be replaced with at least one other aromatic dicarboxylic acid having from 8 to 14 carbon atoms and/or up to 20 mol % can be replaced with an aliphatic dicarboxylic acid having from 2 to 14 carbon atoms.

Mention may be made, as example of aromatic dicarboxylic acids, of terephthalic acid, isophthalic acid, bibenzoic acid, naphthalenedicarboxylic acid, 4,4′-diphenylenedicarboxylic acid, bis(p-arboxyphenyl)methane, ethylenebis(p-benzoic acid), 1,4-tetramethylenebis(p-oxybenzoic acid), ethylenebis(p-oxybenzoic acid) or 1,3-trimethylenebis(p-oxybenzoic acid).

Mention may be made, as example of glycols, of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexanedimethanol. The copolymers comprising polyester blocks and polyether blocks are, for example, copolymers having polyether units derived from polyetherdiols, such as polyethylene glycol (PEG), polypropylene glycol (PPG), polytrimethylene glycol (PO3G) or polytetramethylene glycol (PTMG), dicarboxylic acid units, such as terephthalic acid, and glycol (ethanediol) or 1,4-butanediol units. Such copolyetheresters are described in the patents EP 402 883 and EP 405 227. These polyetheresters are thermoplastic elastomers. They can comprise plasticizers.

(b) As regards the TPUs, mention may be made of the polyetherurethanes which result from the condensation of soft polyether blocks, which are polyetherdiols, and of rigid polyurethane blocks resulting from the reaction of at least one diisocyanate, which can be chosen from aromatic diisocyanates (e.g.: MDI, TDI) and aliphatic diisocyanates (e.g.: HDI or hexamethylene diisocyanate), with at least one short diol. The chain-lengthening short diol can be chosen from the glycols mentioned above in the description of the copolyetheresters. The polyurethane blocks and the polyether blocks are connected via bonds resulting from the reaction of the isocyanate functional groups with the OH functional groups of the polyetherdiol.

Mention may also be made of the polyesterurethanes which result from the condensation of soft polyester blocks, which are polyesterdiols, and of rigid polyurethane blocks resulting from the reaction of at least one diisocyanate with at least one short diol. The polyesterdiols result from the condensation of dicarboxylic acids, advantageously chosen from aliphatic dicarboxylic acids having from 2 to 14 carbon atoms, and of glycols which are chain-lengthening short diols chosen from the glycols mentioned above in the description of the copolyetheresters. They can comprise plasticizers.

(c) As regards the “PEBAs”, or copolymers comprising polyether blocks and polyamide blocks, they result from the polycondensation of polyamide blocks comprising reactive ends with polyether blocks comprising reactive ends, such as, inter alia:

1) polyamide blocks comprising diamine chain ends with polyoxyalkylene blocks comprising dicarboxyl chain ends;

2) polyamide blocks comprising dicarboxyl chain ends with polyoxyalkylene blocks comprising diamine chain ends, which are obtained by cyanoethylation and hydrogenation of aliphatic α,ω-dihydroxylated polyoxyalkylene blocks, known as polyetherdiols;

3) polyamide blocks comprising dicarboxyl chain ends with polyetherdiols, the products obtained being, in this specific case, polyetheresteramides.

The polyamide blocks comprising dicarboxyl chain ends originate, for example, from the condensation of precursors of polyamides in the presence of a chain-limiting dicarboxylic acid. The polyamide blocks comprising diamine chain ends originate, for example, from the condensation of precursors of polyamides in the presence of a chain-limiting diamine.

The number-average molar mass Mn of the polyamide blocks is between 400 and 20 000 g/mol, preferably between 500 and 10 000 g/mol.

The polymers comprising polyamide blocks and polyether blocks can also comprise randomly distributed units.

Use may be advantageously made of three types of polyamide blocks.

According to a first type, the polyamide blocks originate from the condensation of a dicarboxylic acid, in particular those having from 4 to 20 carbon atoms, preferably those having from 6 to 18 carbon atoms, and of an aliphatic or aromatic diamine, in particular those having from 2 to 20 carbon atoms, preferably those having from 6 to 14 carbon atoms.

Mention may be made, as examples of dicarboxylic acids, of 1,4-cyclohexanedicarboxylic acid, butanedioic, adipic, azelaic, suberic, sebacic, dodecane-dicarboxylic and octadecanedicarboxylic acids and terephthalic and isophthalic acids, but also dimerized fatty acids.

Mention may be made, as examples of diamines, of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and di(para-aminocyclohexyl)methane (PACM), and isophoronediamine (IPDA), 2,6-bis(aminomethyl)norbornane (BAMN) and piperazine (Pip).

The following blocks advantageously exist: PA4.12, PA4.14, PA4.18, PA6.10, PA6.12, PA6.14, PA6.18, PA9.12, PA10.10, PA10.12, PA10.14 and PA10.18, the first figure indicating the number of carbon atoms of the diamine and the second figure indicating the number of carbon atoms of the dicarboxylic acid.

According to a second type, the polyamide blocks result from the condensation of one or more α,ω-aminocarboxylic acids and/or of one or more lactams having from 6 to 12 carbon atoms in the presence of a dicarboxylic acid having from 4 to 12 carbon atoms or of a diamine. Mention may be made, as examples of lactams, of caprolactam, oenantholactam and lauryllactam. Mention may be made, as examples of α,ω-aminocarboxylic acid, of aminocaproic, 7-aminoheptanoic, 11-aminoundecanoic and 12-aminododecanoic acids.

Advantageously, the polyamide blocks of the second type are of polyamide 11, of polyamide 12 or of polyamide 6.

According to a third type, the polyamide blocks result from the condensation of at least one α,ω-aminocarboxylic acid (or one lactam), at least one diamine and at least one dicarboxylic acid.

In this case, the polyamide PA blocks are prepared by polycondensation:

of the linear aliphatic or aromatic diamine or diamines having X carbon atoms;

of the dicarboxylic acid or acids having Y carbon atoms; and

of the comonomer or comonomers {Z} chosen from the lactams and the α,ω-aminocarboxylic acids having Z carbon atoms and the equimolar mixtures of at least one diamine having X1 carbon atoms and of at least one dicarboxylic acid having Y1 carbon atoms, (X1, Y1) being different from (X, Y),

said comonomer or comonomers {Z} being introduced in a proportion by weight ranging up to 50%, preferably up to 20% and more advantageously still up to 10%, with respect to the combined polyamide precursor monomers;

in the presence of a chain-limiting agent chosen from dicarboxylic acids.

Use is advantageously made, as chain-limiting agent, of the dicarboxylic acid having Y carbon atoms, which is introduced in excess with respect to the stoichiometry of the diamine or diamines.

According to an alternative form of this third type, the polyamide blocks result from the condensation of at least two α,ω-aminocarboxylic acids or of at least two lactams having from 6 to 12 carbon atoms or of a lactam and of an aminocarboxylic acid not having the same number of carbon atoms, in the optional presence of a chain-limiting agent. Mention may be made, as examples of aliphatic α,ω-aminocarboxylic acid, of aminocaproic, 7-aminoheptanoic, 11-aminoundecanoic and 12-aminododecanoic acids. Mention may be made, as examples of a lactam, of caprolactam, oenantholactam and lauryllactam. Mention may be made, as examples of aliphatic diamines, of hexamethylenediamine, dodecamethylenediamine and trimethylhexamethylenediamine. Mention may be made, as example of cycloaliphatic diacids, of 1,4-cyclohexanedicarboxylic acid. Mention may be made, as examples of aliphatic diacids, of butanedioic, adipic, azelaic, suberic, sebacic and dodecanedicarboxylic acids, dimerized fatty acids (these dimerized fatty acids preferably have a dimer content of at least 98%; preferably, they are hydrogenated; they are sold under the Pripol® trade name by Uniqema or under the Empol® trade name by Henkel) and polyoxyalkylene-α,ω-diacids. Mention may be made, as examples of aromatic diacids, of terephthalic (T) and isophthalic (I) acids. Mention may be made, as examples of cycloaliphatic diamines, of the isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and di(para-aminocyclohexyl)methane (PACM). The other diamines commonly used can be isophoronediamine (IPDA), 2,6-bis(aminomethyl)norbomane (BAMN) and piperazine.

Mention may be made, as examples of polyamide blocks of the third type, of the following:

6.6/6 in which 6.6 denotes hexamethylenediamine units condensed with adipic acid and 6 denotes units resulting from the condensation of caprolactam.

6.6/6.10/11/12 in which 6.6 denotes hexamethylenediamine condensed with adipic acid, 6.10 denotes hexamethylenediamine condensed with sebacic acid, 11 denotes units resulting from the condensation of aminoundecanoic acid and 12 denotes units resulting from the condensation of lauryllactam.

Preferably, the polymer comprises from 1% to 80% by weight of polyether blocks and from 20% to 99% by weight of polyamide blocks, preferably from 4% to 80% by weight of polyether blocks and from 20% to 96% by weight of polyamide blocks and more preferably from 30% to 60% by weight of polyether blocks and from 40% to 70% by weight of polyamide blocks. The mass Mn of the polyether blocks is between 100 and 6000 g/mol and preferably between 200 and 3000 g/mol.

The polyether blocks consist of alkylene oxide units. These units can, for example, be ethylene oxide units, propylene oxide units or tetrahydrofuran units (which results in the polytetramethylene glycol sequences). Use is thus made of PEG (polyethylene glycol) blocks, that is to say those consisting of ethylene oxide units, PPG (polypropylene glycol) blocks, that is to say those consisting of propylene oxide units, PO3G (polytrimethylene glycol) blocks, that is to say those consisting of polytrimethylene ether glycol units (such copolymers with polytrimethylene ether blocks are described in the document U.S. Pat. No. 6,590,065), and PTMG blocks, that is to say those consisting of tetramethylene glycol units, also known as polytetrahydrofuran blocks. The PEBA copolymers can comprise several types of polyethers in their chain, it being possible for the copolyethers to be block or random copolyethers. The permeability to water vapor of the PEBA copolymer increases with the amount of polyether blocks and varies as a function of the nature of these blocks. It is preferable to use a polyethylene glycol polyether block which makes it possible to obtain a PEBA exhibiting good permeability.

The polyether blocks can also consist of ethoxylated primary amines. Mention may be made, as examples of ethoxylated primary amines, of the products of formula:

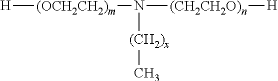

in which m and n are between 1 and 20 and x is between 8 and 18. These products are commercially available under the Noramox® trade name from CECA and under the Genamin® trade name from Clariant.

The soft polyether blocks can comprise polyoxyalkylene blocks comprising NH₂ chain ends, it being possible for such blocks to be obtained by cyanoacetylation of aliphatic α,ω-dihydroxylated polyoxyalkylene blocks, known as polyetherdiols. More particularly, use may be made of Jeffamines (for example, Jeffamine® D400, D2000, ED 2003 or XTJ 542, commercial products from Huntsman, also described in the documents of patents JP 2004346274, JP 2004352794 and EP 1 482 011).

The polyetherdiol blocks are either used as is and copolycondensed with polyamide blocks comprising carboxyl ends or they are aminated in order to be converted into polyetherdiamines and condensed with polyamide blocks comprising carboxyl ends. The general method for the two-stage preparation of PEBA copolymers having ester bonds between the PA blocks and the PE blocks is known and is described, for example, in the French patent FR 2 846 332. The general method for the preparation of the PEBA copolymers of the invention having amide bonds between the PA blocks and the PE blocks is known and described, for example, in the European patent EP 1 482 011. Polyether blocks may also be mixed with polyamide precursors and a chain-limiting diacid in order to prepare polymers comprising polyamide blocks and polyether blocks having randomly distributed units (one-stage process).

Of course, the designation PEBA in the present description of the invention relates equally well to the PEBAX® products sold by Arkema, to the Vestamid® products sold by Evonik®, to the Grilamid® products sold by EMS, to the Kellaflex® products sold by DSM or to any other PEBA from other suppliers.

Advantageously, the PEBA copolymers have PA blocks of PA6, of PA11, of PA12, of PA6.12, of PA6.6/6, of PA10.10 and/or of PA6.14, preferably PA11 and/or PA12 blocks; and PE blocks of PTMG, of PPG and/or of PO3G. The PEBAs based on PE blocks consisting predominantly of PEG are to be ranked in the range of the hydrophilic PEBAs. The PEBAs based on PE blocks consisting predominantly of PTMG are to be ranked in the range of the hydrophobic PEBAs.

Advantageously, said PEBA used in the composition according to the invention is obtained, at least partially, from bioresourced starting materials. Starting materials of renewable origin or bioresourced starting materials is understood to mean substances which comprise bioresourced carbon or carbon of renewable origin. Specifically, unlike the substances resulting from fossil materials, the substances composed of renewable starting materials comprise ¹⁴C. The “content of carbon of renewable origin” or “content of bioresourced carbon” is determined by application of the standards ASTM D 6866 (ASTM D 6866-06) and ASTM D 7026 (ASTM D 7026-04). By way of example, the PEBAs based on polyamide 11 originate at least in part from bioresourced starting materials and exhibit a content of bioresourced carbon of at least 1%, which corresponds to a ¹²C/¹⁴C isotopic ratio of at least 1.2×10⁻¹⁴. Preferably, the PEBAs according to the invention comprise at least 50% by weight of bioresourced carbon with respect to the total weight of carbon, which corresponds to a ¹²C/¹⁴C isotopic ratio of at least 0.6×10⁻¹². This content is advantageously higher, in particular up to 100%, which corresponds to a ¹²C/¹⁴C isotopic ratio of 1.2×10⁻¹², in the case of PEBAs comprising PA11 blocks and PE blocks comprising PO3G, PTMG and/or PPG resulting from starting materials of renewable origin.

Thermoplastic starch, herein known as “TPS”, is understood to mean native starch converted into processable material by plasticizing in the presence of a small amount of water. The plasticized starch, known as “thermoplastic starch”, is obtained in particular with a nonvolatile plasticizer, such as glycerol. This material has many advantages, such as its cost, its biodegradable nature and its origin, resulting from abundant renewable resources. It can be processed with conventional devices of plastics technology. Plasticized starch has a few significant limits, such as its high sensitivity to water, limited mechanical properties and adhesive properties, in comparison with a conventional thermoplastic, and a very lengthy aging, after the processing thereof, before stabilization of its properties (phenomena of retrogradation or densification). Its use in the form of an alloy according to the invention makes it possible to overcome these disadvantages by virtue of the formulation of starch with other compounds and the use of the process according to the invention. According to a preferred embodiment, the percentage of thermoplastic starch in the alloy used represents from 10% to 90% of the weight of the alloy, preferably from 30% to 80%, more preferably from 40% to 70% and more preferably from 50% to 70% of the weight of the alloy.

Any type of starch can be used in the invention. It can be corn, potato, wheat, tapioca or pea starch. The starch can be modified by grafting chemical groups. It can be employed in the following different forms:

native (unmodified) starch: the starch grains are the site of the semicrystalline organization of the two constituent polymers, which are amylose and amylopectin. The degree of polymerization and the proportion of amylose vary according to the botanical origin of the starch.

gelatinized starch: during heating in the vicinity of 80° C. in an aqueous medium, the starch hydrates and swells. A portion of the amylose and then of the amylopectin passes into solution (starching). The suspension then becomes viscous and the starch becomes easier to hydrolyze.

gelled starch—retrograded starch: when the temperature of the aqueous solution decreases, the system becomes gelled and then reorganized into a semicrystalline structure (retrogradation). These reorganized molecules are formed of amylose, of amylopectin and of mixed amylose/amylopectin crystals.

destructured starch, in which form the amylose and amylopectin polymers are dispersed.

In addition to the use of starch, which is a natural material, the use of polyolefin polymers prepared at least partially from bioresourced starting materials makes it possible to further increase the amount of natural materials in the film according to the invention.

The alloy according to the invention can be prepared by any method which makes it possible to obtain an intimate or homogeneous blend comprising the thermoplastic starch and said at least one hydrophilic functional polyolefin (hereinafter FPO) according to the invention, and optionally (a) additive(s) and/or (a) compatibilizing agent(s), such as melt compounding, extrusion, compacting or even roll mill.

More particularly, the alloy according to the invention is prepared by melt blending all the ingredients (starch, plasticizer, water, FPO and optional compatibilizer(s) and additive(s)) in a “direct” process. It is also possible to prepare the alloy according to a two-stage process, the first stage consisting in preparing a concentrated blend of the starch, plasticizer and water, in order to form a TPS matrix, and then a second stage consisting in diluting the TPS by blending with the FPO matrix.

Use is advantageously made of the normal devices for blending and kneading of the thermoplastics industry, such as extruders, extruders of twin-screw type, in particular self-cleaning engaging corotating twin-screw extruders, and kneaders, for example co-kneaders of Buss brand or internal mixers. In this process, the ingredients can either be dry blended and introduced into the feed hopper or else the hydrophilic FPO can be introduced via a side feed into the TPS or into a pre-molten starch+plasticizer+water blend.

It is recommended that the preparation of the alloys of the invention (the compounding) and the processing thereof be carried out under the mildest possible conditions in terms of temperature and shear rate. In order to do this, reference may be made to the reference: O. Schacker, Plastics Additives and Compounding, April 2002, pages 28-33.

The alloys according to the invention exhibit an excellent performance/cost ratio for obtaining novel waterproof-breathable materials. Difference performances are obtained according to the FPO/TPS ratios used. In order to improve the compatibility of the blend, the addition of compatibilizers. The latter is preferred in the present invention.

In contrast to the multilayers manufactured by coextrusion of plasticized starch and thermoplastic polymers, the alloys according to the invention do not have problems of interfacial instabilities due in particular to the differences in chemical behavior and rheology of the materials brought together in the die. Furthermore, the alloys according to the invention do not have the problems of reduction in the hydrophilicity properties generally encountered with biocomposites. This is because the introduction of lignocellulose fibers into biopolyesters or into a plasticized starch matrix results in a reduction in the hydrophilicity properties related to the presence of the more hydrophobic fibers.

Another subject matter of the present invention is an adhesive and ultrathin waterproof-breathable film, characterized in that it comprises an alloy of thermoplastic starch and of hydrophilic FPO, said FPO comprising at least 10% by weight, preferably at least 20% by weight, preferably at least 30% by weight, preferably at least 40% by weight, preferably at least 50% by weight, of polyethylene glycol (PEG) and/or of metal salt, with regard to the weight of the FPO. Advantageously, the percentage of thermoplastic starch represents from 10% to 90% and the percentage of hydrophilic FPO represents from 90% to 10% of the weight of the alloy in the film.

According to one embodiment, the waterproof-breathable film of the invention is prepared directly after the manufacture of the alloy according to the following stages: preparing a blend of the FPO(s) with thermoplastic starch (or starch, water and a plasticizer) and then melting the blend by heating to a temperature greater than the melting point of the polymer(s) and than the melting point of the starch, so as to form a homogeneous blend in the form of an alloy. The thermoplastic alloy obtained is then drawn in order to form a film. The heating of the FPO(s) can be carried out separately from the stage of heating the starch, the molten FPO(s) and the starch being subsequently blended.

According to a preferred embodiment of the process of the invention, the following stages are carried out:

a) making available a blend of starch, of plasticizer and of water;

b) making available hydrophilic FPO as defined above;

c) extruding the blend of stage a) and then adding the FPO from stage b) to the blend at the end of extrusion, generally at a temperature greater than the melting point of the polymer(s) of stage a) and than the melting point of the starch;

d) drawing the blend in order to form a film.

Preferably, stage c) is carried out at a temperature within the range from 100° C. to 300° C., preferably from 150° C. to 250° C.

According to one embodiment, the stage of drawing the blend is carried out by extrusion/blow molding. According to an alternative embodiment, the stage of drawing the blend is carried out by cast film extrusion.

The process of the invention makes it possible to maintain the FPO at a sufficiently high temperature, greater than the melting point of the hydrophilic FPO, in order to obtain ultrathin films, that is to say with a thickness of less than or equal to 25 μm, while limiting the risk of degradation of the starch and of the FPO(s). Preferably, the heating or extrusion temperature before drawing the film is within the range from 100° C. to 300° C., preferably from 150° C. to 250° C.

Advantageously, the waterproof-breathable film according to the invention has a thickness of less than or equal to 25 μm, preferably within the range from 5 to 25 μm.

Another subject matter of the invention is a laminated product (hereinafter laminate) comprising at least one textile material and at least one waterproof-breathable film according to the invention, said film adhering to at least one surface of the textile material with a peel strength within the range from 0.5 to 50 N.

Advantageously, the film according to the invention is in particular applied to a textile material by any known process, preferably without using adhesive between the film and the textile. Mention may be made, by way of example, of the extrusion-coating of a film of the alloy over the textile, or else the hot pressing (thermal lamination) of the film over a textile or between two textiles, at a temperature sufficient for the film to become impregnated and to trap the fibers of the textile. According to an alternative embodiment or an embodiment in combination with the preceding one(s), mention may also be made of adhesive bonding using an adhesive joint, preferably a water-based adhesive joint, that is to say comprising less than 5% by weight of solvent, with regard to the adhesive joint composition. It turns out that the films using an alloy according to the invention exhibit better adhesion to textiles, even without adhesive, in comparison with the existing waterproof-breathable films.

According to a preferred embodiment, the process for processing the alloys used to produce waterproof-breathable materials and laminates according to the invention is characterized in that the compositions are applied on a cast extrusion or blown extrusion line, in the molten state, at a temperature of at least 120° C., in order to form a film having a minimum thickness of 5 μm. This type of process also makes it possible to optimize the transformation conditions in order to prepare films which are as thin as possible, advantageously between 5 and 50 μm in thickness, preferably with a thickness within the range from 5 to 25 μm, resulting from in-line blendings of the materials according to the invention diluted in varied proportions and without having microperforations. By varying the temperature and drawing-rate parameters of the line, it is possible to control the thickness of the films. According to another preferred embodiment, the process of processing the compositions which are used for producing waterproof-breathable films and laminates according to the invention is characterized in that the compositions are applied in the molten state on an extrusion-coating line to a textile or on an extrusion-lamination line between two textiles, such as a nonwoven made of fibrous material and/or any other textile material, including paper, in order to form a complex with a grammage of at least 5 g/m². According to a known process, the film according to the invention is extruded and then coated in the molten state onto the textile. Preferably, the film exhibits a thickness of between 5 and 50 μm and preferably between approximately 5 and 10 μm. Advantageously, in the context of an application by extrusion-coating, from 10 to 50 g/m² of thermoplastic film are deposited on the textile.

In the present description of the invention:

“textile material” or “textile” is understood to mean any material produced from fibers or filaments and any material, including paper and board, forming a porous membrane characterized by a length/thickness ratio of at least 300;

“fiber” is understood to mean any synthetic or natural material characterized by a length/diameter ratio of at least 300;

“filament” is understood to mean any fiber of infinite length.

The textiles include in particular mats of fibers (dressings, filters or felt), rovings (dressings), yarns (to be sewn, to be knitted or to be woven), items of knitwear (straight, circular or fully-fashioned), woven products (traditional, jacquard, multiple, two-sides, multi-axial, 2D and semi-3D) and many others. According to a preferred embodiment of the invention, said at least one textile material is provided in the form of a porous membrane, of a woven textile or of a nonwoven textile.

Advantageously, said at least one textile material comprises synthetic fibers, in particular synthetic fibers obtained from bioresourced starting materials, natural fibers, artificial fibers manufactured from natural starting materials, mineral fibers and/or metal fibers.

Advantageously, said textile comprises synthetic fibers obtained from bioresourced starting materials, such as polyamide fibers, in particular polyamide 11 fibers. Advantageously, said textile additionally comprises natural fibers, such as cotton, wool and/or silk, artificial fibers manufactured from natural starting materials, or mineral fibers, such as carbon fibers, glass fibers, silica fibers and/or magnesium fibers.

Preferably, said textile material, whatever its form, is manufactured from at least one of the following materials: polypropylene, polyether, polyester and/or cotton.

The textile is chosen in particular from fabrics or textile surfaces, such as woven, knitted, nonwoven or mat surfaces. These articles can, for example, be fitted carpets, carpets, furniture coverings, surface coverings, sofas, curtains, bedding, mattresses and pillows, clothing and medical textile materials.

The textile according to the invention advantageously constitutes a felt, a filter, a film, a gauze, a cloth, a dressing, a layer, a fabric, an item of knitwear, an item of clothing, a garment, an item of bedding, an item of furniture, a curtain, a compartment covering, a functional technical textile, a geotextile and/or an agrotextile.

Said textile is advantageously used in the medical field, hygiene, luggage, the clothing industry, the garment industry, domestic or household equipment, furniture, fitted carpets, the automobile industry, industry, in particular industrial filtration, agriculture and/or the construction industry.

Such a film exhibits both good durability and improved permeability to water vapor. The film retains over time its property of barrier to the external elements which might infiltrate into the textile. The improvement in the permeability of the film to water vapor promotes ventilation through the textile.

### EXAMPLES

Waterproof-breathable films were prepared from blends comprising various proportions of a hydrophilic FPO, of a copolyether-block-amide PEBA, of another functionalized polyolefin and of thermoplastic starch. The FPO used in the examples below is a PEG-grafted FPO (27% of PEG), in this instance PEG-grafted ethylene (79.9%)/butyl acrylate (17%)/maleic anhydride (3.1%) terpolymer (Lotader BX3460), or an ionomeric FPO of the Surlyn® range from DuPont.

The TPE used in the examples below belongs to the range of the hydrophilic PEBAs sold by Arkema and in particular those for which the polyether block derives from polyethylene glycol. In this instance, it is Pebax® MV3000.

The other functionalized polyolefin optionally used in some examples is Lotryl® 28MA07, which is a copolymer of ethylene with n-methyl acrylate at an acrylate content by weight of 28%. The starch used is modified starch (TPS 3947) sold by Roquette.

The waterproofness-breathability (or MVTR) of the various films having the compositions A to M is measured according to the standard ASTM E96, BW method, 38° C./50% Relative Humidity, with respect to a 25 μm film.

The adhesion of the substrates is directly related to the peel strength values. The peel tests are preferably carried out within a period of time of between 2 hours and 48 hours after the manufacture of a laminate comprising an adhesive film of 25 μm, after extrusion-coating, on a nonwoven polypropylene textile. A peel test (according to the standard ISO 11339) was carried out on the laminates of each of tests A to I; the rupturing between the film and the textile is initiated, on a strip of laminate with a width of 15 mm, by a cutting tool and then drawing is carried out simultaneously on the waterproof-breathable film and the textile at a rate of 200 mm/minute.

The compositions of the various blends are summarized in table 1 below.

Examples A-G are comparative. Examples H to M are according to the invention.

TABLE 1

| | | % by | | | | | |
|---|---|---|---|---|---|---|---|
| | | weight of | | % by weight | | | |
| | | PEG- | | of | % by | | Waterproofness- |
| | | grafted | % by | functionalized | weight of | | breathability |
| | | polyolefin | weight of | polyolefin | thermo- | Thickness | MVTR |
| | | (Lotader | ionomeric | (Lotryl | plastic | of the | (g/m²/day) |
| | Test | BX3460) | FPO | 28MA07) | starch | film (μm) | for 25 μM |
| Comparative | A | 100 | 0 | 0 | 0 | 25 | 420 |
| examples | B | 80 | 0 | 20 | 0 | 25 | 320 |
| | C | 70 | 0 | 30 | 0 | 25 | 280 |
| | D | 30 | 0 | 70 | 0 | 25 | 120 |
| | E | 20 | 0 | 80 | 0 | 25 | 105 |
| | F | 0 | 0 | 100 | 0 | 25 | 80 |
| | G | 0 | 100 | 0 | 0 | 25 | 500 |
| Examples | H | 50 | 0 | 0 | 50 | 25 | 1200 |
| according | I | 40 | 0 | 40 | 20 | 25 | 600 |
| to the | J | 10 | 0 | 80 | 10 | 25 | 200 |
| invention | K | 0 | 50 | 0 | 50 | 25 | 1400 |
| | L | 0 | 40 | 40 | 20 | 25 | 725 |
| | M | 0 | 10 | 80 | 10 | 25 | 180 |

1. The use of thermoplastic starch in the manufacture of an adhesive and ultrathin waterproof-breathable film, said thermoplastic starch being provided in the form of an alloy with at least one hydrophilic functionalized polyolefin obtained either by copolymerization or by grafting of a polyolefin backbone with an unsaturated monomer, said unsaturated monomer being grafted by PEGs and/or forming a metal salt.

2. The use as claimed in claim 1, in which the percentage of thermoplastic starch represents from 10% to 90% of the weight of the alloy.

3. The use as claimed in claim 1, in which the hydrophilic polyolefin comprises at least 10% by weight of polyethylene glycol (PEG) and/or of metal salt, with regard to the weight of polyolefin.

4. The use as claimed in claim 1, in which the alloy additionally comprises at least one hydrophilic TPE chosen from copolymers comprising polyamide blocks and PEG blocks (PEBAs), copolymers comprising polyester blocks and PEG blocks (COPEs), copolymers comprising polyurethane blocks and PEG blocks (TPUs) and their blends, said hydrophilic TPE representing a content of 1% to 99% of the weight of the alloy.

5. An adhesive and ultrathin waterproof-breathable film, wherein the film comprises an alloy of thermoplastic starch and of hydrophilic polyolefin, said polyolefin comprising at least one polyethylene unit and at least one unsaturated monomer to which is grafted a content of at least 10% by weight polyethylene glycol (PEG) and/or of metal salt, with regard to the weight of the polyolefin.

6. The film as claimed in claim 5, in which:
the percentage of thermoplastic starch represents from 10% to 90%,
the percentage of hydrophilic polyolefin represents from 90% to 10%,
of the weight of the alloy.

7. The film as claimed in claim 5, in which said functionalized polyolefin comprises a grafting by a monomer chosen from the group consisting of unsaturated carboxylic acids, unsaturated carboxylic anhydrides, vinyl monomers, acrylic monomers and a mixture of these.

8. The waterproof-breathable film as claimed in claim 7, in which the functionalized polyolefin is chosen from the group consisting of ethylene/acrylic ester copolymers, ethylene/acrylic ester/maleic anhydride copolymers and ethylene/acrylic ester/glycidyl methacrylate copolymers.

9. The waterproof-breathable film as claimed in claim 5, in which the film has a thickness of less than or equal to 25 μm.

10. A process for the manufacture of the film as claimed in claim 5, comprising the stages of:
a) making available a blend of starch, of plasticizer and of water;
b) making available the hydrophilic polyolefin;
c) extruding the blend of stage a) and then adding the polyolefin of stage b) to the blend at the end of extrusion;
d) drawing the blend in order to form a film.

11. The process as claimed in claim 10, in which the stage of drawing the blend is carried out by extrusion/blow molding.

12. The process as claimed in claim 10, in which the stage of drawing the blend is carried out by cast film extrusion.

13. The process as claimed in claim 10, in which stage c) is carried out at a temperature within the range from 100° C. to 300° C.

14. A laminated product comprising at least one textile material and at least one waterproof-breathable film as claimed in claim 5, said film adhering to at least one surface of the textile material with a peel strength within the range from 0.5 to 50 N.

15. The laminate as claimed in claim 14, in which said at least one textile material is provided in the form of a porous membrane, of a woven textile or of a nonwoven textile.

16. The laminate as claimed in claim 14, in which said at least one textile material comprises synthetic fibers, natural fibers, artificial fibers manufactured from natural starting materials, mineral fibers and/or metal fibers.

17. The laminate as claimed in claim 14, in which said at least one textile material constitutes a felt, a filter, a film, a gauze, a cloth, a dressing, a layer, a fabric, an item of knitwear, an item of clothing, a garment, an item of bedding, an item of furniture, a curtain, a compartment covering, a functional technical textile, a geotextile and/or an agrotextile.

18. The use of a film as claimed in claim 5 in the medical field, hygiene, luggage, the clothing industry, the garment industry, domestic or household equipment, furniture, fitted carpets, the automobile industry, industrial filtration, agriculture and/or the construction industry.
